(19) United States
(12) Patent Application Publication
(10) Pub. No.: US 2005/0091681 A1
(43) Pub. Date: Apr. 28, 2005

(54) Systems and methods for video storage and display

(76) Inventors: Bruce Borden, Los Altos, CA (US); Russell Brand, Redwood City, CA (US)

Correspondence Address: STERNE, KESSLER, GOLDSTEIN & FOX PLLC, 1100 NEW YORK AVENUE, N.W., WASHINGTON, DC, 20005, US

(21) Appl. No.: 10/967,289

(22) Filed: Oct. 19, 2004

Related U.S. Application Data
(60) Provisional application No. 60/513,045, filed on Oct. 22, 2003.

(51) Int. Cl. H04N 7/173; H04N 7/167; H04N 7/16; H04L 9/00

(52) U.S. Cl. 725/31; 725/131; 725/139; 725/151; 380/282

(57) ABSTRACT

Systems and methods for cost effectively making video content available to users are disclosed. In particular, a prescient abundant viewer (PAW) is described. A PAW includes a content receiver, a media vault encoder, a media vault interface, a media vault decoder, a digital rights management module and an access rights module. A PAW stores and accesses content on a media vault. A PAW includes a smart card reader to support a plethora of authentication, billing, and access privilege scenarios. In another embodiment, a PAW includes a media vault interface and a media vault decoder. According to an embodiment of the invention, a media vault includes a high capacity IDE drive with special encoding to support sophisticated digital rights management and access rights management. Methods are provided for the storing, distribution and viewing of digital content stored on a media vault.

### CROSS REFERENCE TO RELATED APPLICATIONS

This application claims the benefit of priority to U.S. Provisional Patent Application No. 60/513,045, filed Oct. 22, 2003, which is incorporated herein by reference in its entirety

### BACKGROUND OF THE INVENTION

1. Field of the Invention

The invention relates to video storage and display, and more particularly, to a media vault used to store videos for display, a player that supports a new digital rights management approach, and facilitating payment from viewers to content owners.

### BACKGROUND OF THE INVENTION

Numerous approaches have been taken to deliver video to homes. Basic television (TV), cable, and satellite broadcasts continue to provide the most common methods of home delivery of video programming. Premium services, such as pay-per-view (PPV), typically supported by set top boxes provide another means to deliver videos to residential users. Additionally, a variety of trials have taken place to deliver videos through video on demand (VOD) systems.

Each of these delivery mechanisms has shortcomings that limit the ability of residential users to conveniently view the videos of their choice. In particular, traditional television broadcasts are extremely limited in the number of channels broadcast and the availability of program choices. Furthermore, while a vast proliferation of channels have indeed increased the number of movies or programs available through cable or satellite broadcasts that can be viewed at a specific time, the choices are still extremely limited in the context of the vast amount of video and program content that exists. In each of these delivery mechanisms, the viewer is constrained in large part to the scheduling whims of the broadcaster and cannot watch a program or movie when he prefers. While the introduction of VCRs and other recording devices provide some flexibility as to viewing time, users are still limited in the choice of content available. In addition, most users can not program a VCR, so VCRs are used almost exclusively as players.

Premium services, such as pay-per-view (PPV) also have significant shortcomings. Most cable systems offer PPV—in which you either use a set-top box to order a movie, or call a phone number to enable a movie. Almost all PPV solutions force the viewer to watch the movie from beginning to end (i.e., with no pause, rewind, etc.). Additionally, the movies start at fixed times which further limits a viewer's options.

VOD systems suffer from a variety of shortcomings. Most importantly, however, VOD systems are expensive to implement, and have not been widely deployed. VOD systems have typically relied on existing cable networks. As a result, VOD systems are expensive to deploy because the cable infrastructure was not designed to support video on demand. VOD systems also vary widely on the amount of control the user has—from little more than PPV to full pause, rewind and even multiple camera control to see some of the scenes from different points of view.

In light of the shortcomings associated with electronic mechanisms to remotely distribute video content to households, video rental stores, such as Blockbuster, have proliferated. Video rental stores provide to users the flexibility of a large selection of movies and the ability to view those movies when and how they want, provided the user has a VCR or DVD player.

Nonetheless, the current movie rental paradigm has a number of shortcomings that result in increased costs and inconvenience to users. First, a complex rental charge structure often makes it difficult to determine when videos must be returned and exactly how much one is paying for a video rental. For example, often when multiple videos are rented at the same time, the charges and return dates for videos will be different. This leads to confusion and the imposition of late fees that often exceed the original cost of renting the movie.

Furthermore, the videos are often damaged, because they are simply worn out from over use, or perhaps have suffered heat damage from being left in a car in the Sun. Finally, the rental process is often confusing and unnecessarily time consuming. Video stores are often poorly arranged making it difficult to determine whether the desired film is available and occasionally errors in re-stocking the video lead to a renter taking home a different video from what he thought he had selected. Moreover, the video stores often have long lines, limited supplies, and limited hours.

Recently, to address the shortcomings of the current movie rental paradigm, video rental services available through the Internet have developed. One such example is Netflix. These services address certain aspects of the shortcomings described above, by removing the fees for late returns and removing rental store visits, but to use them requires planning ahead and delays while videos are in the mail.

What are needed are cost effective systems and methods to allow users convenient, high quality access to video programming and other content.

### SUMMARY OF THE INVENTION

The invention is directed to systems and methods for cost effectively making video content available to users. In particular, a prescient abundant viewer (PAW) is described. A PAW includes a video receiver, a media vault encoder, a media vault interface, a media vault decoder, a digital rights management module and an access rights module. A PAW stores and accesses content on a media vault. A PAW can be located at a user premise, in an assembly comparable to that of a VCR. A PAW includes a smart card reader to support a plethora of authentication, billing, and access privilege scenarios. Furthermore, all content in a media vault will be encrypted, and either the media vault has electronics to decrypt the contents when the proper keys are received, or the PAW has the electronics to decrypt the material.

According to an embodiment of the invention, a media vault includes a high capacity IDE drive with special encoding to support sophisticated digital rights management and access rights management. Through data compression, a media vault can be used to effectively store hundreds of full-length movies. A set of methods is provided to store, distribute and use content stored on a media vault.

The invention can be used with a wide range of digital content, including but not limited to movies, television shows, slide shows, a collection of still images, books, textual materials, computer programs, video games, scientific databases, engineering tables, product catalogs, regulatory updates, industry directories, phone books, music videos, music audio tracks, audio books, recorded radio programs, technical manuals, scripts. legal documents and the like.

The invention provides a number of benefits. First, the invention reduces the need for individuals to rely on traditional methods of viewing movies at home. As discussed above, these traditional means—such as cable TV, video store rental or VOD systems—all have significant shortcomings. Second, the invention provides a secure mechanism to protect intellectual property rights of content owners. Third, the invention provides significant flexibility for developing different types of usage and access privileges for viewers of video content stored on a media vault. And, fourth, the invention allows a user to have convenient access to a large volume of movies, and to only pay for viewing the movie after the movie has been decided to be viewed.

In particular, large amounts of content can be made available to users on media vaults for their viewing and users only have to pay for content that they actually use or view from the media vault. That is, customers have the option of paying for content when they use or watch it, which is expected to represent the typical way of using the media vault, rather than when it is loaded onto a media vault. As a result, users can have a tremendous amount of content (e.g. hundreds of movies) lying around at home waiting to be viewed without the user committing money.

Another benefit of the invention is that through use of the invention content owners do not need to trust distribution channels to protect their digital content. Theft of digital content can be controlled in that content distributors do not have access to the content—only end users do.

Further embodiments, features, and advantages of the invention, as well as the structure and operation of the various embodiments of the invention are described in detail below with reference to accompanying drawings.

### BRIEF DESCRIPTION OF THE FIGURES

The invention is described with reference to the accompanying drawings. In the drawings, like reference numbers indicate identical, or functionally or structurally similar elements. The drawing in which an element first appears is indicated by the left-most digit(s) in the corresponding reference number.

FIG. 1 is a diagram of prescient abundant viewer, according to an embodiment of the invention.

FIG. 2 is a diagram of an example front panel of a prescient abundant viewer, according to an embodiment of the invention.

FIG. 3A is a diagram of a media vault enclosure, according to an embodiment of the invention.

FIG. 3B is a diagram of a rear view of a media vault enclosure, according to an embodiment of the invention.

FIG. 4 is a flow chart of a method to store video content on a media vault using a web interface, according to an embodiment of the invention.

FIG. 5 is a flow chart of a method to store video content on a media vault when content is continuously transmitted, according to an embodiment of the invention.

FIG. 6 is a flow chart of a method to store and distribute content on a media vault through a retail store, according to an embodiment of the invention.

FIG. 7 provides a flow chart of a method of using content on a media vault from the perspective of a user, according to an embodiment of the invention.

### DETAILED DESCRIPTION OF THE INVENTION

While the invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

While the detailed description primarily focuses on an example related to video, namely movies, the invention is not limited to this example. The invention can be used with a wide range of digital content, including but not limited to movies, television shows, slide shows, a collection of still images, books, textual materials, computer programs, video games, scientific databases, engineering tables, product catalogs, regulatory updates, industry directories, phone books, music videos, music audio tracks, audio books, recorded radio programs, technical manuals, scripts, legal documents and the like.

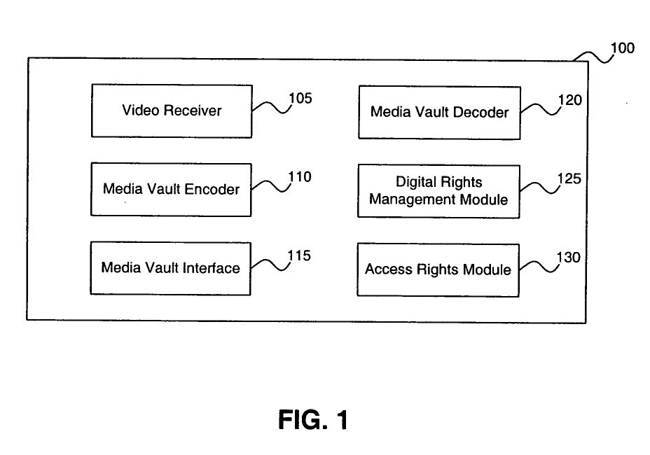

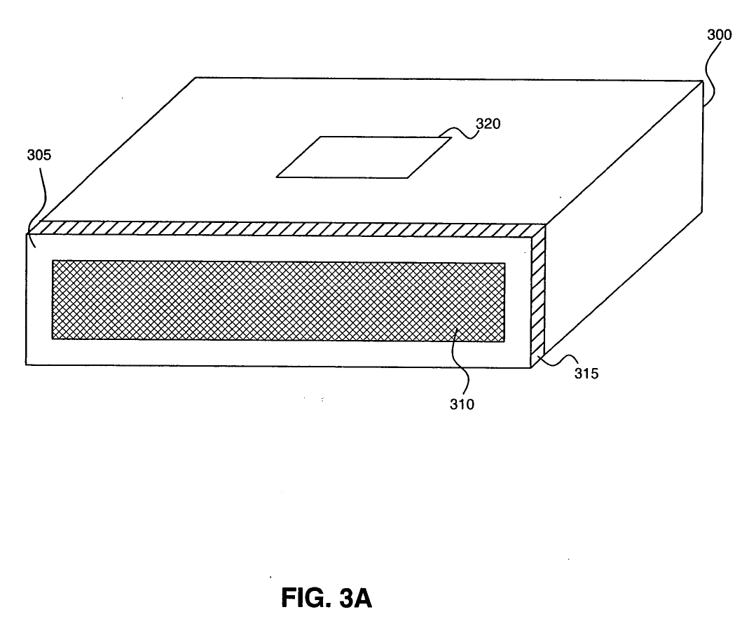

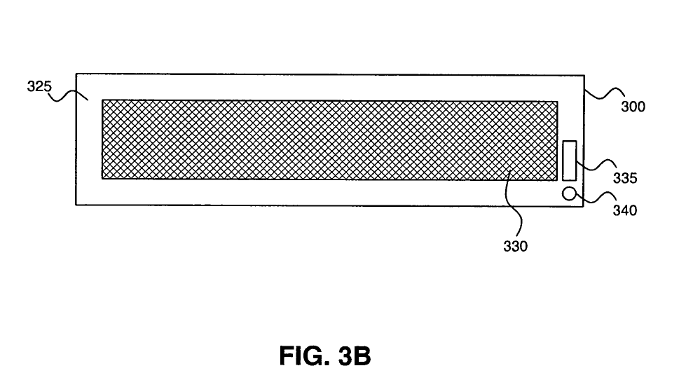

FIG. 1 illustrates functional components of prescient abundant viewer (PAW) 100, according to an embodiment of the invention. PAW 100 provides a convenient means for users to store and make available for viewing on a television or other video display system hundreds of full length movies and other video programming through the use of a media vault, as is discussed with reference to FIG. 3. A PAW, such as PAW 100, can easily be stored at a user's home much like VCRs, digital video recorders (DVR) and personal video recorders (PVR) are today. Moreover, a PAW can be designed to include some or all of the functions associated with a VCR, DVR and/or PVR. However, while DVRs have limited access to content which is sent openly over the air, through satellite or over cable, the invention does not suffer from this limitation. Rather the invention can access a wide range of digital content that can be distributed through a variety of means as discussed herein.

PAW 100 includes video receiver 105, media vault encoder 110, media vault interface 115, media vault decoder 120, digital rights management module 125, and access rights module 130. In an alternative embodiment, PAW 100 does not include video receiver 105 or media vault encoder 110. In this embodiment, PAW 100 does not have the ability to capture transmitted data, but rather is used as a player for media vaults that may be obtained from retail stores or other sources.

Video receiver 105 includes software and hardware to receive and decode video content that is being transmitted to PAW 100. Video receiver 105 has several alternative approaches for receiving video. First, video receiver 105 can receive traditional cable or satellite broadcasts to capture movies or other programming. Second, video receiver 105 can capture video received from a VCR, DVD and the like. Third, video receiver 105 can capture compressed data containing movies from a service provider that specializes in delivering content for a media vault. Video receiver 105 can include analog tuners, MPEG-4 decoders and/or MP3/MP4 decoders. In addition, video receiver 105 can be used to receive other forms of signals, including but not limited to audio signals, data files (e.g., software programs), and text files (e.g., electronic texts). In general video receiver 105 can be any type of content receiver for receiving any form of transmitted digital data.

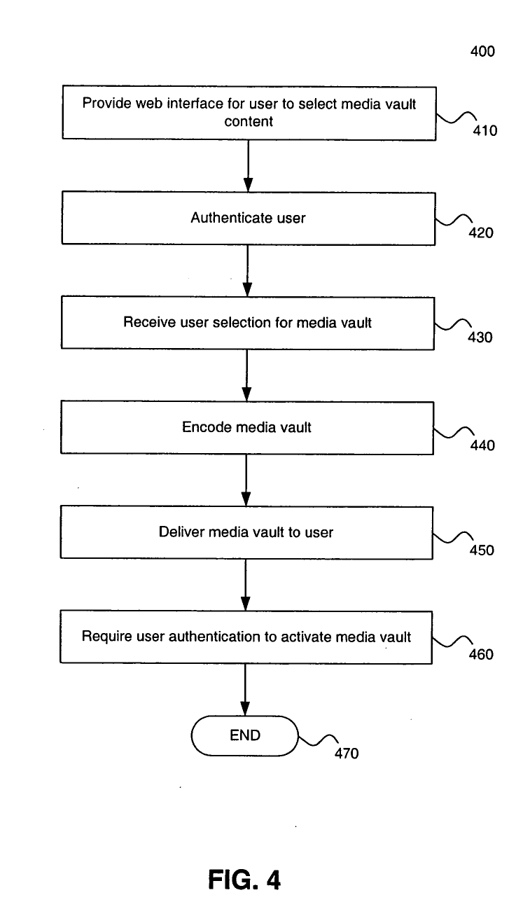

In the third case, service providers can send compressed data streams of movies over idle cable channels, satellite connections or DSL connections. These compressed data streams can include movie headers that can identify the movie genre, the movie title, duration, pricing information, access privilege levels and other information. Video receiver 105 will monitor these compressed data streams to identify header information for movies that a user desires to add to their media vault. Thus, for example, an individual might want a copy of the movie “Pretty Woman” loaded into a media vault. In one embodiment, the user would program PAW 100 to record “Pretty Woman” when it became available. Upon identifying header information associated with “Pretty Woman,” video receiver 105 would capture and begin processing “Pretty Woman” for storage in a media vault. Specific delivery schemes associated with transmitting videos are discussed more fully with respect to FIGS. 4, 5, and 6.

Media vault encoder 110 receives received video data from video receiver 105 and encodes the data for storage onto a media vault. Media vault interface 115 provides an interface for inserting a media vault into PAW 100. A PAW, such as PAW 100, can have multiple media vault interfaces.

Media vault decoder 120 decodes compressed data stored on a media vault, and reformats that data into a digital or analog output video signal that can be transmitted to a television or other video display device for viewing.

Digital rights management module 125 ensures the intellectual property protection of content contained on a media vault. Digital rights management module 125 gathers digital rights information from information contained within content on a media vault and also through a smart card that can be read by PAW 100. Digital rights management module 125 will consist of software and hardware to interpret this information and ensure that the digital rights of content owners are not violated. Included among this software will be encryption software to ensure that a strong cryptographic authorization system exists and allow for accessing content stored on media vaults, which can have encrypted content.

Access rights module 130 provides a means for a user to limit access to videos contained within a media vault, while also providing a means to manage usage privileges dictated by a service provider or content owner. Access rights module 130 will receive usage privilege information through information stored on a smart card, information received through video receiver 105, or through a combination of both.

With the use of smart cards, PAW 100 can allow a wide variety of viewing options. For example, in a liberal case, the user can be allowed to watch a video any number of times, stopping it, rewinding it, etc. for a single fee. In a more conservative setup, the user may only be allowed to view a video multiple times in a given period (e.g., one week) without incurring further charges. Based on access rights contained on a smart card, a PAW may allow the user to watch the first five minutes of any movie without charge. Moreover, viewing policies can vary on a title by title basis or could vary over time. For example, as content got older, the access rights could adjust such that longer previews could be permitted or lower fees could be imposed.

Additional access right options can also be implemented. In one example, users could be given service options at different prices to allow them to view movies multiple times over a fixed time period, such as a month or year. Further embodiments can include providing user ads before and during a movie. These ads could be based on user demographic information, and enable the user to pay a lower service fee when accepting ads. For users that do not have PAWs at each location where they may want to watch a video (e.g., minivan for the kids, vacation home, laptop computer) a video can be recorded onto a DVD, which would be a more expensive PAW pricing option. The user could be charged a fee for doing this that is comparable to purchasing a DVD, but without the distribution overhead costs.

Multiple smart cards can be used with a single PAW. In fact, a PAW can be designed to read any PAW smart card. A single master smart card can be associated with a PAW. The master smart card has a private pin or other authentication means. In an embodiment, when a media vault is ejected from a PAW, the master smart card will also be ejected from a PAW. In this way, a user will be encouraged to take the master card to a video store when exchanging media vaults. The master smart card can also be used to set up access rights for use of a PAW and other non-master smart cards. A smart card interface can be in a PAW or can be provided remotely.

A PAW can support multiple media vaults. For example, when a user obtains a video (on a rented media vault or downloaded), they can copy it to an internal media vault and store the video indefinitely. There may be a fee to unlock a video for unlimited viewing that would be different than the single viewing fee. Once unlocked, however, there would probably be no additional fee or a reduced fee for burning to a single DVD; but additional fees for making multiple copies. A PAW would know if a DVD is protected and would, as a matter of policy, not allow it to be copied. The PAW would allow the video to be stored on a media vault and played without limitation or allow and enforce any other usage policy that was appropriate. PAW software could be updated to reflect legal/policy changes and could vary from region to region to conform to local laws, customs and marketing plans.

An indicator of which videos have been “unlimitedly unlocked” can be stored on a smart card rather than on the media vault itself. In this manner, a person carrying his smart card on vacation can review movies (or other content) from local media vaults rather than having to carry his media vault with him. Similarly, a child left at a daycare with his smart card could have access to the appropriate content from media vault at the daycare center.

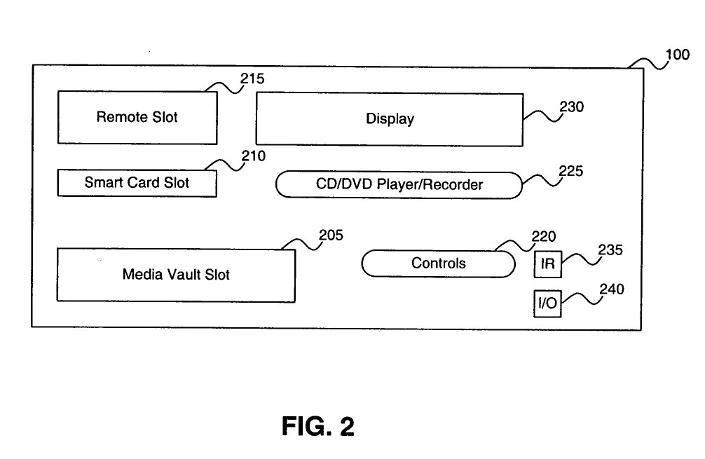

FIG. 2 illustrates an example front panel for PAW 100, according to an embodiment of the invention. The front panel includes media vault slot 205, smart card slot 210, remote slot 215, controls 220, CD/DVD Player/Recorder 225, display 230, infra-red (IR) port 235, and input/output ports 240. Smart card slot 210 provides an interface for inputting a smart card. Remote slot 215 can be used to store a PAW remote control while not in use. Controls 220 provide user controls for powering the system on, recording, selecting movies to view, and the like. CD/DVD Player/Recorder 225 can be included to provide a means for playing or recording video and audio contained on CDs and DVDs. CD and DVD data can be copied onto a media vault. Display 230 provides a visual display of the status and condition of PAW 100. IR port 235 supports the use of a remote controller for PAW 100. Similarly, input/output ports 240 provide standard input and output interfaces, for example, a serial port, for controlling PAW 100 or providing another means of exchanging data with PAW 100.

The back panel of PAW 100 (not shown in the Figures) can include a secondary media vault slot and typical interfaces for video recording devices, such as antenna (BNC) out, S-VHS in/out, optical/coax digital in/out, analog video/audio in/out, digital audio in/out, Ethernet, USB and phone plug interfaces.

FIGS. 3A and 3B provide front and rear views of an example media vault enclosure 300, according to an embodiment of the invention. A media vault enclosure houses a media vault. A media vault is a specialized disk drive based on technology used to develop very low cost IDE disk drives that are available for personal computers. IDE disk drives can access twenty to thirty megabytes of data per second, well in excess of the four megabyte/second speeds that are necessary to view movies or other video. A media vault using reasonable data encoding schemes can store between fifty to more than two hundred movies, assuming one to two gigabyte of data per movie and two hundred gigabyte disks. A media vault can also be referred to as a bag of plenty (BOP).

FIG. 3A illustrates a front view of an enclosure for media vault 300, according to an embodiment of the invention. Media vault 300 enclosure includes front panel 305, front grating 310, textured grip rim 315 and label 320. An IDE SATA drive resides within the enclosure for media vault 300. Any adequately fast inexpensive disks may be used, although the preferred embodiment uses serial ATA interface 2.5 in disks. In another embodiment, a modular removable disk package, referred to as iVDR, under development by an industry consortia can be used.

The drive is shock mounted within the enclosure. Additionally, as will be known by individuals skilled in the relevant arts, current disk drives that could be used to support a media vault application are drop/impact resistant rated at greater than 200 g non-operating shock, which represents a greater force than a drive would sustain from a five foot drop onto concrete. Airflow is from front to back with a fan contained within the enclosure. Front panel 305 opens to allow mounting of a media vault drive within the enclosure. Front grating 310 permits airflow through the front of the enclosure, while textured grip rim 315 provides easy opening and closing of front panel 305. Front grating 310 is further designed to prevent moisture (e.g., spills) from getting inside. Label 320 provides a means to identify the information stored on the media vault. The media vault drive can include a serial ATA connection involving seven wires, power (+12, +5, and +3.3 V) leads and two ground wires for a total of twelve wires.

FIG. 3B illustrates a rear view of an enclosure for a media vault 300, according to an embodiment of the invention. The rear view of media vault enclosure includes rear panel 325, rear grating 330, connection door 335 and door release hole 340. Rear grating 330 permits airflow through the back of the enclosure. Connection door 335 permits access for a connector to electrically couple the media vault drive to a recording device or PAW. Door release hole 340 provides a special keyed entry to open the connection door, which will typically be locked for security purposes.

FIGS. 4, 5, and 6 provide three methods by which a user can obtain a media vault with user selected content. These methods are not intended to be exhaustive, rather they are intended to provide example embodiments.

FIG. 4 provides a flow chart of method 400 to store video onto a media vault using a web interface, according to an embodiment of the invention. Method 400 begins in step 410. In step 410, an Internet web interface is provided for a user to select content to be delivered to a media vault. For example, a service provider can provide a web interface that identifies individual movie titles for a user to select. Alternatively, or in conjunction movies can be organized for selection by genre, by lead actor, or by date of original release. Thus, for example, a user could select all westerns from 1950 to 1960 that starred John Wayne, plus “Pretty Woman” and the top ten movies of 1970. The web interface would provide pricing information for each type of package, and could contain account information for a particular user.

In step 420, a user is authenticated. For example, a user could be authenticated by providing a pin number, a credit card number and/or a password. Additionally, biometric information could be used to authenticate the user, such as a fingerprint or the like.

In step 430, user selections for content to be loaded to a media vault are received. For example, a user can make their movie selections and transmit that request to a service provider. In step 440, a media vault is encoded with the desired content. For example, a service provider would gather the content requested and load it onto a media vault. In step 450, the media vault content is delivered to the user. For example, a media vault might be delivered using a courier service. In an alternative embodiment, a user could pick up an encoded media vault at a video store, such as Blockbuster. The video store could simply have an industrial size PAW-like device that would write to many media vaults; in this manner, no specialized distribution network would be needed to stock the video stores themselves. In another alternative embodiment, the content selected could be delivered over a high speed connection to a PAW containing a media vault. The PAW would store the information on a media vault. Included in the transmission could be access privileges that would be encoded onto either a media vault or smart card, or both.

In step 460, user authentication is required to authenticate user access to content on the media vault. For example, if a media vault was delivered via courier, encoded on the media vault would be encrypted authentication information provided by the user when requesting the content (e.g., credit card, biometric information). A user would be required to insert a smart card into a PAW containing matching authentication information or enter it through other means to enable access to the content on the media vault. In step 470, method 400 ends.

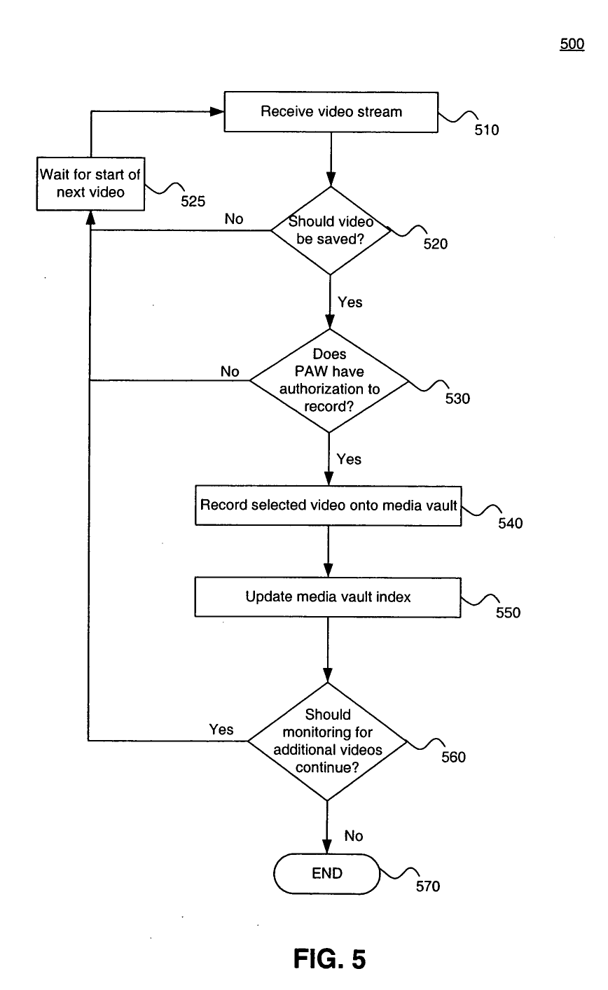

FIG. 5 provides a flow chart of method 500 to store video content onto a media vault when content is continuously transmitted, according to an embodiment of the invention. Method 500 is based on a business model in which service providers that have vast content libraries continuously transmit compressed data streams containing that content over high speed connections to PAWs. For example, a service provider might continuously transmit content over excess capacity on cable or satellite systems in which PAWs were monitoring. Under this scenario, each PAW could capture new content as it went by and store it on a media vault. Rather than collecting all of the new content, each PAW could have a profile that would be used to determine what type of content to capture; for example “all Westerns” or “Everything with a G rating.” The movies could be re-sent many times, so (1) that people who join the system later can still obtain the movies, (2) the PAW does not need to have enough storage to catch everything the first time it is transmitted, and (3) the system can transparently recover from network outages or other problems.

A number of approaches could be used to determine when and how movies were made available. For instances, the frequency with which a movie is made available can be a function of its popularity. Each user can look at a directory of all videos available and flag those to “store,” with common options for all new releases, or all Sci-Fi, old romance, etc. New releases could be available at home within a few hours of release—no rushing to the video store. In fact, new releases could be made available to PAW sooner than they would be in the video store. If desired, the new releases could be sent out hours or days in advance of the “first allowable watching time” with the system knowing to capture and store them immediately but not play them until that allowable time. An entire “season” of content could be preloaded on a media vault with each “episode” given a separate “first allowable watching time.”

Method 500 provides a flowchart illustrating an example process that could be used to capture video content being delivered under this business model. Method 500 begins in step 510. In step 510, one or more video streams are concurrently received. For example, PAW 100 could receive a video stream over a cable connection. In step 520, a determination is made whether a movie within the video stream should be stored. For example, PAW 100 can contain user instructions on the specific videos to store or the type of videos to store. These could be entered through controls 220, or through a PC connected to PAW 100 that provides a convenient selection menu. If a determination is made not to store the current movie, method 500 proceeds to step 525 to wait until the start of the next video. If a determination is made to store the current movie, method 500 proceeds to step 530. Video content does not need to be sent serially or on a single channel. Rather, content can be delivered in random chunks across multiple channels in a manner similar to spread spectrum encoding for wireless connections, which can improve security, reliability and performance. The PAW simultaneously records several different movies and/or from several different streams.

In step 530, a determination is made whether the PAW has authorization to record the selected movie. For example, a user may need to insert a smart card into PAW 100 that contains pre-paid credits that will allow the user to store movies. Each movie can contain header information related to the cost of the movie. If the pre-paid credits do not exceed the cost of the movie, the movie will not be stored. If a determination is made that proper authorization does not exist method 500 proceeds back to step 525, otherwise method 500 proceeds to step 540. In step 540, the selected video is recorded onto a media vault. In step 550, an index for a media vault is updated. For example, an index will be created that can be accessed through a PAW, such as PAW 100, to view what movie titles are stored on the media vault. In the “pay when you view” model, prepayment for recording would not be necessary or appropriate.

In step 560, a determination is made whether monitoring for additional videos should continue. If a determination is made that monitoring should continue, then method 500 proceeds to step 525 to wait for the start of the next video. If a determination is made that monitoring should stop, method 560 proceeds to step 570 and ends.

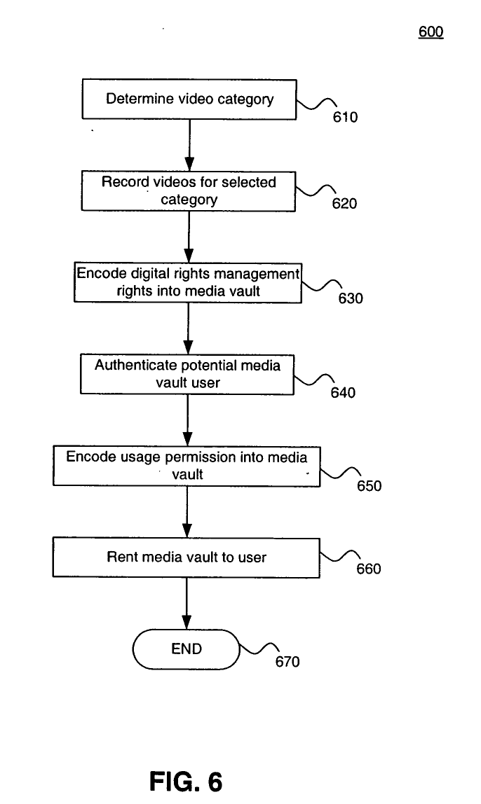

FIG. 6 illustrates a flowchart of method 600 for storing and distributing content on a media vault through a retail store, according to an embodiment of the invention. Method 600 would be used in a business model in which users rent preloaded media vaults from service providers, such as, for example, blockbuster or a grocery store providing videos. In such a business model, the renter might be granted the right to view any ten movies, or as many as they wished over a specified period, or other similar rules as deemed appropriate by the content owners. Since the media vault and PAW enforce such rules, there is not the same need to have return times or late penalties that are commonly found in existing video rental business models. Method 600 begins in step 610. In step 610, a video category is determined. For example, a service provider may choose to create media vaults by genre, such as westerns, drama, horror, and x-rated movies. Alternatively, a service provider may chose to create media vaults based on most popular titles for a particular year, Oscar winners, movies by certain actors or actresses, and the like. In step 620 videos for the selected category are recorded onto a media vault. For example, can record multiple copies of selected categories onto media vaults for rent.

In step 630 digital management rights are encoded into the media vault. For example, different levels of copyright protection may exists for the selected content. These rights would be encoded into a media vault, such that when played by a PAW, such a PAW 100, the digital rights associated with each movie would be honored. In step 640, a potential user is authenticated. In one scenario, prior to renting a media vault a customer would need to provide some form of identification, such as a pin number, a credit card number or biometric information. Authentication also could be used to ensure that under age individuals did not rent pornographic or R-rated versions of movies. In step 650, usage permissions are encoded into the media vault. Alternatively, usage permissions can be encoded into a user's smart card. For example, a customer might pay for unlimited viewing of movies. In this case, unlimited usage permissions would be encoded into the media vault or into a user's smart card. In an alternate embodiment, a customer can simply leave a deposit for the media vault. When the customer views a movie, the appropriate charges will be charged to his smart card. When the customer returns to the video store, he can insert the smart card into a reader and the charges for the movies viewed can be determined. Alternatively, a PAW can be connected to the Internet and a smart card read remotely. In this case, a previous arrangement can exist where a customer's credit card or other account can be deducted for the charges on the smart card and the smart card balance cleared. In step 660 a media vault is rented to a user. In step 670 method 600 ends.

Methods 400, 500 and 600 described approaches to load content onto media vaults primarily from the perspective of a service provider. Common across each approach is that large amounts of content can be made available to users on media vaults for their viewing and that users only have to pay for content that they actually use or view from the media vault. That is, customers have the option of paying for content when they use or watch it, rather than when it is loaded onto a media vault. As a result, users can have a tremendous amount of content (e.g. hundreds of movies) lying around at home waiting to be viewed without the user committing money.

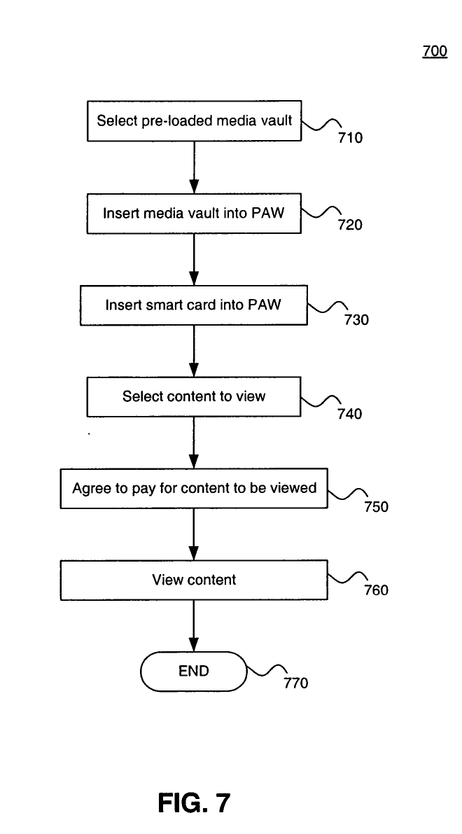

FIG. 7 provides a flow chart of method 700 for using content on a media vault from the perspective of a user, according to an embodiment of the invention. Method 700 begins in step 710. In step 710, a pre-loaded media vault is selected. For example, a user can go to a store providing media vaults, which could include for example, Blockbuster, Wal-Mart, or a grocery store. The user could then select a pre-loaded media vault that contains a large amount of content. The user would likely provide a deposit for the media vault, and also could add money to his smart card. The user might also buy a media vault which could be filled and refilled with content as desired and appropriate. Alternatively, the user could specify what should be loaded onto the media vault, as in Method 400 or could load a media vault through the process described in Method 500 without going to a retail store. The user would then take the media vault home or to any other place where a PAW exists.

In step 720, the user would insert the media vault into a PAW, such as PAW 100. The user can choose to insert the media vault immediately to view content or, more likely, would store the media vault with the preloaded content for future viewing. In step 730, the user would insert a smart card into the PAW. In step 740, the content to be viewed is selected. For example, a user can select to view a particular movie, such as Pretty Woman.

In step 750, the user would agree to pay for the content to be viewed. For example, the PAW could instruct a television to display the charges for the requested content and request that the user agree to pay for the content before viewing takes place. There are many payment alternatives that are possible. Common to all alternatives is the option to pay for content when the content is actually used. In one scenario, when the user agrees to pay for the content to be viewed, credits on the user's smart card could be deducted for the price of the content. For example, if a user wants to view the selection and a sufficient account balance exists, the PAW can debit the smart card and request a decryption key from the card. The PAW uses the key to decrypt the content to be viewed. In an alternate embodiment, the PAW can enforce the digital rights management rules, and does not need to receive a key from the smart card.

In step 760, the selected content is viewed. For example, a user can watch the selected movie. Alternatively, the content could be copied or used in other ways provided that those options are permitted and the user agrees to pay the fees associated with alternative uses. In step 770, method 700 ends.

Other features that could be incorporated into a PAW system using a media vault include, but are not limited to the following:

Public key enabled media vault. Video camera recordings can be stored on a media vault that could not be viewed without the proper key. For example, home videos that can not be viewed without key (e.g., erotica) or video monitoring of day care center that would be archived but could not be viewed without a court order

Each camera can have its own private key. This approach could be used to certify that content is from certain source and has not been tampered. Cipher block chaining, involving concatenating signatures associated with video content to insure order/sequence could be used. The media vault and/or camera could have a tamper-resistant timesource so that each image could be reliably time/date stamped.

Use media vaults in digital cameras. These media vaults would likely have a smaller form factor with only 5-10 hours. For example, several drive manufacturers are now delivering 1.8″ PCMCIA form-factor drives with up to 10 GB of storage. At current digital video rates, this is less than 1 hour, but with compression, storage levels greater than those of mini-DVDs and digital-8 tapes can be achieved. Media vault enclosures could be developed to hold different size media vault disks. An adapter that will hold a PCMCIA drive and plug into a standard BOP carrier can be created. This would allow direct physical transfer from video camera to PAW without cabling. The video can be transferred to another media vault, edited, etc.

Append only/logging media vault. A command to permanently disable write—e.g., blow wire to write circuit; or automatic when full could be employed. This approach could be useful for surveillance.

Media vault that self-limits what can be stored. Signed material that determines violence, sex, etc. Could have different types of ratings, such as CBN rating (Christian Broadcasting Network), or certified by PBS. Combining this with a custom editing ability, groups like CBN could easily produce “child appropriate” versions of any video very soon after it came out. In this manner, concerned parents would be able to let their child see all the movies that the child's friends were talking about without being exposed to the portions that they fear might be harmful to the child.

Digital notary service associated with a media vault, in which a cryptographic hash (or other content signature) is sent to a notary, combined with a timestamp, and sent back to certify the date of a record. This could be useful for securing medical records for compliance with the Health Insurance Portability and Accounting Act of 1996 (HIPPA).

Embed a very accurate battery-driven clock in the media vault, which could be useful for surveillance purposes.

Provide bookmarks, section skips, rating authorization and version indication functions within a media vault and PAW.

A media vault could be used for control and distribution of any digital content. This includes Television Shows, Slide Shows, Collections of Still Images, Books and Textual Materials, Computer Software, Video Games, Scientific Databases, Engineering Tables, Product Catalogs, Regulatory Updates, Industry Directories and Phone Books, Music Videos, Music Audios, Audio Books, Recorded Radio Programs, Technical Manuals, Scripts, Legal Documents, etc.

A media vault could be used for software distribution. For example, a user could receive a media vault that has all Microsoft home software—operating systems, office productivity, drafting, money management, etc., then with a smart card, any item can be “purchased” when it is needed. When a user loads an application to their computer, the user's smart card would be debited for the amount of that particular application. The same media vault can be used over and over—so a corporation would only need a few media vaults for all of their software needs. The mechanisms of the media vault system would keep track of how many copies of which software were installed and when, so that the intellectual property owner could be properly paid. Keeping track of this in the current office environment is surprisingly difficult. This also simplifies audits and makes it easy to find the necessary materials to install another copy of software onto another machine.

This concept can extend to video games. A user could purchase a video game media vault for a small amount which enables the first level or two, then purchase additional levels, weapons, creatures, wizards, spells, etc. as the user progresses through the game. The “first allowable watching time” concept can be used for contests so that everyone starts at the same time.

Add commentary, subtitles, translations, etc. to content without distributing content. A review of a movie could be done with the audio review synchronized to the video for users. Adding resequencing information without distributing content. In this way intellectual property rights owner could still get paid when derivative works are produced. By making this easy, anyone can become a translator, commentator, or critic/sensor. For example, a group such as the Christian Broadcasting Network could create viewing rules for their clientele. Each content owner can control what can be done to his content. Rules could include cutting sequences, changing/blanking audio, blurring portions of frames (e.g. covering up indecent objects) etc. Creation of simple tools involving time periods to cut, time periods to blank out, time periods with rectangle sized for use to blur objects and time periods to display certain text can facilitate simple modification of content. Restrictions on this editing/augmentation process could be specified by the content owner and enforced by the media vault and PAW system. Contents owners concerned with artistic integrity might specify that no alterations can be made.

Multiple camera views. Multiple sequences—perhaps by rating. For example, parents could watch an X-rated version not available in the theatres, or they can see the R-rated theatre version. The kids can see the sanitized PG-13 version. Note that the common scenes are only stored once and since most of the movie is common scenes, have a dozen version ranging from G-rated to XXX would only increase the storage needs by a few percent. The different versions could be priced differently with credit given for the less expensive version previously purchased. Different versions could be developed for both traditional (3:4) and high definition television (9:16) formats of the same movie.

A media vault could support fast viewing with frequency shift audio, which could be useful for adult education.

A media vault could pause removal between words and skip to next paragraph. This could be combined with frequency shift audio.

Real-estate virtual tours could be contained on a media vault. For example, a realtor can create a media vault specific to the customer's geography and preferences.

Preference tracking on smart-card; find movies “I'd like”; could work when I go into the rental store and plug my smart-card into a kiosk.

Audio (music, concerts, lectures) may lend itself to the media vault concept—especially if the media vault contains the music videos to go along with hit songs.

Tracking where and when a user fast-forwarded or backed-up/repeated. Provide this information to the content owners or researchers to allow them to create better content.

Media vaults could be filled with high priced education video seminar material. The continuing education group of a company could then hand these out to their employees and pay only for the content that was actually used. Large organizations could easily add commentary or otherwise customize these materials for their use. Such commentary could include company internal confidential information that would not need to be shown to the original content creators. And, with the present invention, the content owners can still be appropriately compensated.

For smart cards that have a near real time method of reporting usage, this information could be aggregated to allow content owners to quickly determine how well their content was doing and to decide whether to engage additional marketing strategies in particular markets or to perhaps alter pricing.

People could “pre-select for download” particular not-yet-existing-content. Statistics on this could be made available to content creators who might then prioritize work. For example, if many people pre-ordered the PG-13 version of a movie and few did so the G or R version, the content producers might give additional attention to that cut. Similarly for the French language version compared to the Russian language version or if many more people pre-selected the “next sequel to Friday the 13^{th}” and few to “the next sequel to Star Wars,” the former may be produced more quickly.

In terms of pre-ordering the “language version”, such demand could allow a value-added market for translators/dubbers/subtitlers who would create that supplemental content independently from the primary content owner. The payment system could divide payment for viewing this derivative work between these augmentors and the original content owner; either by giving the original content owner whatever he was charging and the augmentor the difference from the composite price he demanded or through any other means found appropriate.

This divided payment for derivative works can be used for any or all of the altered versions including the creation of the “child safe version” by CBN.

Parental control could be set to allow a child to view only a certain amount of time per day or a particular type of content). In this way the child could use his “half hour per day” over the course of a week to see a feature length film. Similarly, the parental control could prevent the child from using the system after 10 μm on a school night.

Content owners might specify, on a per title basis, certain times and conditions where content can be viewed at a discount or free. Or times that the content cannot be view at all. For example, a children's cartoon might be free on Christmas day; but not viewable at all on Sunday's during church hours.

A media vault system could be configured to always fill up the unused space with things that the view was likely to like, or things that the service provider would like him to watch. These might include free educational, religious or promotional programming.

### Conclusion

Exemplary embodiments of the present invention have been presented. The invention is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the invention.

1. A system for providing access to content, comprising:
(a) a content receiver that receives content from a source;
(b) a media vault encoder that encodes said content onto a media vault;
(c) a media vault interface that provides an interface for inserting a media vault into said system; and
(d) a media vault decoder that decodes compressed data stored on a media vault.

2. The system of claim 1, further comprising a digital rights management module that ensures intellectual property protection of content contained on a media vault.

3. The system of claim 1, further comprising an access rights module that enables content owners to manage usage privileges.

4. The system of claim 1, further comprising a smart card interface.

5. The system of claim 1, wherein a media vault includes an IDE disk drive.

6. The system of claim 1, wherein a media vault includes an iVDR removable disk package.

7. The system of claim 1, wherein a media vault is public-key enabled, wherein data content can not be viewed without a proper key.

8. The system of claim 1, wherein said media vault has a tamper-resistant timesource that allows stored images to be reliably time-stamped.

9. The system of claim 1, wherein said media vault decoder recognizes private keys associated with video input sources to ensure that videos are viewed only upon entry of a valid private key corresponding to the stored video.

10. The system of claim 1, wherein said source is a cable television network, satellite system, VCR player or DVD player.

11. The system of claim 1, wherein said content is movies, television shows, slide shows, a collection of still images, books, textual materials, computer programs, video games, scientific databases, engineering tables, product catalogs, regulatory updates, industry directories, phone books, music videos, music audio tracks, audio books, recorded radio programs, technical manuals, scripts or legal documents.

12. The system of claim 11, wherein said movies includes a movie header comprising a movie genre, movie title, movie duration, pricing information, or access privilege levels for each movie.

13. A system for providing access to content, comprising:
(a) a media vault interface that provides an interface for inserting a media vault into said system; and
(b) a media vault decoder that decodes compressed data stored on a media vault.

14. The system of claim 13, further comprising a digital rights management module that ensures intellectual property protection of content contained on a media vault.

15. The system of claim 13, further comprising an access rights module that enables content owners to manage usage privileges.

16. The system of claim 13, further comprising a smart card interface.

17. The system of claim 13, wherein a media vault includes an IDE disk drive.

18. The system of claim 13, wherein a media vault includes an iVDR removable disk package.

19. The system of claim 13, wherein a media vault is public-key enabled, wherein data content can not be viewed without a proper key.

20. The system of claim 13, wherein said media vault decoder recognizes private keys associated with video input sources to ensure that videos are viewed only upon entry of a valid private key corresponding to the stored video.

21. The system of claim 13, wherein said content is movies, television shows, slide shows, a collection of still images, books, textual materials, computer programs, video games, scientific databases, engineering tables, product catalogs, regulatory updates, industry directories, phone books, music videos, music audio tracks, audio books, recorded radio programs, technical manuals, scripts or legal documents.

22. The system of claim 21, wherein said movies includes a movie header comprising a movie genre, movie title, movie duration, pricing information, or access privilege levels for each movie.

23. A method for viewing content stored on a media vault, comprising:
(a) selecting a media vault with data content;
(b) inserting the media vault into a viewer;
(c) inserting a smart card into the viewer;
(d) selecting content to be viewed from the media vault;
(e) deciding whether to pay for the content to be viewed; and
(f) viewing the selected content.

24. The method of claim 23, wherein step (a) selecting a media vault with data content occurs at a retail store.

25. The method of claim 23, wherein step (a) data content is preloaded onto the media vault.

26. The method of claim 23, wherein step (a) further comprises determining the data to be loaded onto a media vault.

27. The method of claim 23, wherein step (e) further comprises responding to a price displayed on a monitor to view the selected content.

28. The method of claim 23, wherein step (f) further comprises paying for the selected content when the selected content is viewed.

29. The method of claim 28, wherein step (f) further comprises authorizing a debit from a smart card.

30. The method of claim 23, further comprising adding commentary, subtitles, translations to content without disturbing the original content.

31. The method of claim 23, further comprising adding bookmarks.

32. The method of claim 23, wherein the data content is movies, television shows, slide shows, a collection of still images, books, textual materials, computer programs, video games, scientific databases, engineering tables, product catalogs, regulatory updates, industry directories, phone books, music videos, music audio tracks, audio books, recorded radio programs, technical manuals, scripts or legal documents.

33. A method to store video onto a media vault when content is continuously transmitted, comprising:
(a) providing an interface to a user to select content to be delivered to a media vault;
(b) authenticating the user;
(c) receiving user selections for content to be loaded to a media vault;
(d) encoding the content selected to a media vault;
(e) delivering the media vault to the user; and
(f) requiring user authentication to allow the user to access content on the media vault.

34. The method of claim 33, wherein step (a) the interface is provided through the Internet.

35. The method of claim 33, wherein step (a) the content is movies, wherein the movies are organized based on movie genre, lead actor, or date of original release.

36. The method of claim 33, wherein step (b) authenticating the user is conducted by validating a user provided pin number, credit card number or password.

37. The method of claim 33, wherein step (e) delivering the media vault is done by a courier service.

38. The method of claim 33, wherein step (e) further comprises encoding encrypted authentication information on the media vault, wherein said authentication information includes user credit card or biometric information.

39. The method of claim 33, wherein the content is movies, television shows, slide shows, a collection of still images, books, textual materials, computer programs, video games, scientific databases, engineering tables, product catalogs, regulatory updates, industry directories, phone books, music videos, music audio tracks, audio books, recorded radio programs, technical manuals, scripts or legal documents.

40. A method to store data content onto a media vault using Internet connections, comprising:
(a) receiving one or more data content streams;
(b) determining whether data within a data content stream should be stored;
(c) determining whether authorization exists to store a requested data content stream;
(d) recording a selected data content stream onto the media vault;
(e) updating an index for the media vault to reflect the selected data content recorded in step (d); and
(f) determining whether to monitor for additional data content streams to be recorded.

41. The method of claim 40, wherein step (a) the data content stream is a video stream.

42. The method of claim 40, wherein step (a) receiving one or more data content streams occurs serially.

43. The method of claim 40, wherein step (a) receiving one or more data content streams occurs in parallel.

44. The method of claim 40, wherein step (a) further comprises receiving random data blocks of the one or more data content streams on multiple channels in a spread spectrum-like fashion.

45. The method of claim 40, wherein step (d) multiple data content streams are recorded.

46. The method of claim 40, wherein the content is movies, television shows, slide shows, a collection of still images, books, textual materials, computer programs, video games, scientific databases, engineering tables, product catalogs, regulatory updates, industry directories, phone books, music videos, music audio tracks, audio books, recorded radio programs, technical manuals, scripts or legal documents.

47. A method for distributing video content on a media vault through a retail store, comprising:
(a) selecting one or more video categories;
(b) recording video content from the selected video categories onto a media vault;
(c) encoding digital management rights into the media vault;
(d) authenticating a potential user;
(e) encoding usage permissions into a media vault or into a potential user's smart card; and
(f) renting a media vault to the potential user.
